(19) United States
(12) Patent Application Publication
(10) Pub. No.: US 2022/0194707 A1
(43) Pub. Date: Jun. 23, 2022

(54) SYSTEM AND METHOD FOR WAVE-BASED ORDER FULFILLMENT

(71) Applicant: FabFitFun, Inc., Los Angeles, CA (US)

(72) Inventors: Julian Van Erlach, Walnut, CA (US); John Jensen, Fullerton, CA (US); Ben Chandler, Pomona, CA (US); Nathan Goodrich, Los Angeles, CA (US); Mark Gavin, Arcadia, CA (US)

(21) Appl. No.: 17/558,432

(22) Filed: Dec. 21, 2021

Related U.S. Application Data
(60) Provisional application No. 63/129,193, filed on Dec. 22, 2020.

(51) Int. Cl. B65G 1/137; G06Q 10/08; G06V 10/141

(52) U.S. Cl. CPC B65G 1/1373; B65G 1/1371; B65G 2209/02; G06V 10/141; G06Q 10/087

(57) ABSTRACT

Disclosed are systems and methods for warehouse inventory management and order fulfillment. The disclosed system provides a dynamic order fulfillment mapping can prove desirable and provide a basis for a wide range of inventory applications, such as optimizing the warehouse and inventory management process for gift box subscription services and sellers.

### CROSS-REFERENCE TO RELATED APPLICATIONS

This application claims priority to U.S. Provisional Application Ser. No. 63/129,193, which was filed Dec. 22, 2020, the disclosure of which is hereby incorporated by reference in its entirety and for all purposes.

### FIELD

The present application generally relates to order fulfillment in a warehouse environment. More specifically, but not exclusively, the present disclosure describes computerized systems, methods, and apparatuses for improved order fulfillment systems during a wave picking process.

### BACKGROUND

Order fulfillment is the process of receiving inventory shipments, storing the inventory, receiving customer orders, picking and packing orders to satisfy the order, and shipping the order to the customer. The process starts with a customer placing an order and ends once they receive it. As retail giants have adopted online-based shopping, customer expectation around the speed and cost of shipping have also shifted. Customers want their order now. And a seller's ability to fulfil these demands can directly impact an online merchant's business.

To better route and manage inventory, some warehouses rely on pick to light systems. Pick to light is a type of order-fulfillment technology designed to improve picking accuracy and efficiency, while simultaneously lowering labor costs. It is paperless-alphanumeric displays and buttons at item storage locations show pickers or putters which location to pick from or put to.

For example, a warehouse can include storage racks that are partitioned into one or more inventory storage areas, such as a designated shelf on a rack. Each inventory storage area one can be identified with an alphanumeric display (e.g., a display and/or an LED light) and/or a button.

An operator at an induct station scans a tote (or shipping carton barcode or wave identifier (ID) that is attached to the items of one or more of these totes). Based on the scan, a selected alphanumeric display shows the operator the indicated storage or pick from area (e.g., the LED turns on). At the indicated storage area, the display indicates how many items should be picked.

The operator picks the item(s), places them in a holding container, and presses a button to confirm completion of the task. The system continues in this way, illuminating each sector for picking until all items have been picked and placed in their respective holding containers.

In addition to the alphanumeric display, pick to light systems can include colors to signify different tasks statuses and an expanded display capable of more detailed information or instructions.

Put to light is essentially the inverse of a pick-to-light system. A put-to-light system guides operators to place specific in-coming items into specific locations wherein locations may be associated with a customer or store order; and items may be batch-picked for gains in picking efficiency.

Although pick-to-light systems can increase productivity and efficiency, as well as minimize picking errors, training time, and effort, conventional systems have a few drawbacks. For example, both pick-to-light and put-to-light systems work best at high densities. Specifically, for high density areas, the units are being picked more often per unit of time due to less travel distance per pick. It's quicker for the operator to identify the right item using the clear lighting system. However, conventional pick-to-light and put-to-light systems are not as efficient for low-density picking within the space covered by a picker.

As a further disadvantage, conventional pick-to-light systems typically either show which items should be picked in a pick area for each unique order; or if numerous orders require exactly the same items/SKUs from the same pick locations, then pick area lights may remain on for the duration of the identical orders. However, there exists a need for the same pick to light work areas to either treat orders as unique or identical automatically based on the composition of the orders, e.g., orders having unique item combinations in work areas, or all orders in a sequence or wave having the same SKU/item pick combinations in all affected work areas.

In view of the foregoing, a need exists for an improved system and method for warehouse management and order fulfillment to overcome the aforementioned obstacles and deficiencies of conventional pick to light systems.

### BRIEF DESCRIPTION OF THE DRAWINGS

FIG. 1 is an exemplary diagram illustrating a prior art pick-to-light system.

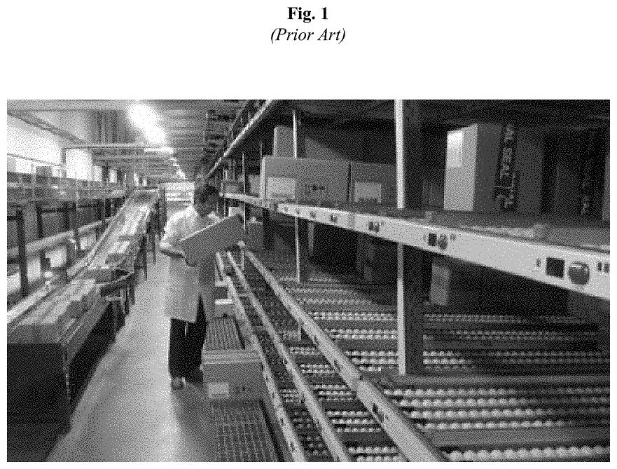

FIG. 2 is an exemplary top-level block diagram illustrating one embodiment of an order fulfillment system.

FIG. 3 is an exemplary top-level flow diagram illustrating one embodiment of a process for generating a wave for the order fulfillment system of FIG. 2.

FIGS. 4 and 5 are simplified functional block diagrams of computer hardware platforms that may be used to implement functionalities of the order fulfillment system.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

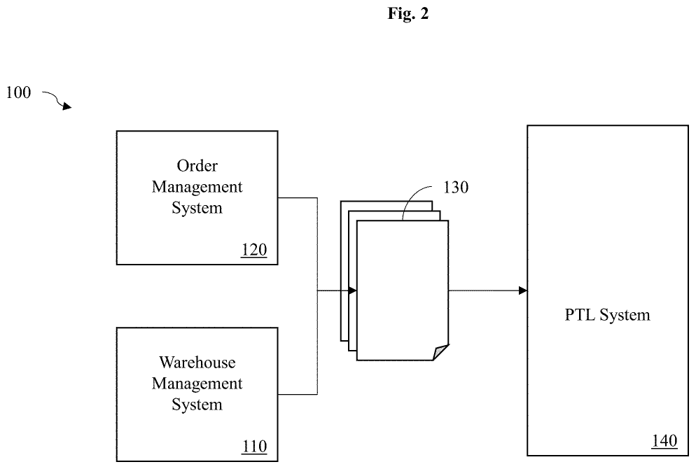

The present disclosure describes a number of methods and computerized systems for warehouse management and order fulfillment. Since currently available pick-to-light systems and waving methods are deficient because they cannot maximize order fulfillment efficiency for multiple orders at a time and routing efficiency for a single order, a system for order fulfillment that provides a dynamic order fulfillment mapping can prove desirable and provide a basis for a wide range of inventory applications, such as optimizing the warehouse and inventory management process for gift box subscription services and sellers. This result can be achieved, according to one embodiment disclosed herein, by an order fulfillment system 100 as illustrated in FIG. 2. As described herein, the order fulfillment system 100 advantageously can differentiate between, and thus enable efficient picking for, groups of orders with identical SKU combinations compared to orders with unique combinations.

Turning to FIG. 2, the order fulfillment system 100 includes a pick-to-light system 140. The pick-to-light system 140 typically triggers a light associated with an item that is part of an order that a picker is directed to pick from an inventory storage location. The order fulfillment system 100 integrates the pick-to-light system 140 with a warehouse management system (WMS) 110 and an order management system (OMS) 120. However, additional enterprise resource planning (ERP) systems, supply chain management systems, or other host systems can be included in the order fulfillment system for better warehouse controls, as desired. For example, additional warehouse control systems can be included to satisfy differences in warehouse and/or order sizes.

Although shown and described as a pick-to-light system 140 for exemplary purposes only, other automated picking systems can be used with the order fulfillment system 100 as desired. For example, an A-frame automated picking system can be used. The A-frame system is a self-contained automated piece picking machine designed to process a high volume of less than full case orders at a low operating cost. In some embodiments, the A-frame system includes at least a storage module, a picking module, an order collection module, and a control. The storage module can use a series of vertical channels positioned in an “A” shape to straddle the order collection module. The picking module is positioned between the storage modules to pick the quantity of a line of items in a specific order. The order collection module includes a tote or conveyor belt running through the center of the A-frame system to collect picked items to a designated order space or tote on the belt as it passes picking modules. The control is standalone or integrated and interfaces with one or more host systems to receive orders and upload post-picked information. The automated picking system can further include one or more automated sub-systems that can include, for example, packing stations, returns sorting, mailing systems, and a control system that coordinates fulfillment options.

The WMS 110 feeds system item data associated with a selected order to the pick-to-light system 140. The OMS 120 creates mappings of items with an order, which indicates to the WMS 110 the selected items that are associated with a selected order. Additionally and/or alternatively, the OMS 120 can associate orders with a wave of orders 130, such as shown in FIG. 2. The wave of orders 130 can include one or more orders with an identical item composition.

Based on the data received from the WMS 110, the pick-to-light system 140 associates slotted item locations with a light and triggers the light associated with an item that is part of a current order.

The wave of orders 130 is defined in part by both the number of orders having a predefined item composition attribute and the composition attribute itself. As used herein, the composition is the item composition of the order (e.g., stock keeping unit (SKU) A, F, G or SKU L, M, X). Accordingly, the wave of orders 130 are created with an attribute that is a function of the attributes of more than one order. The attribute of more than one order is a function of the similarity/differences in the item composition of the orders.

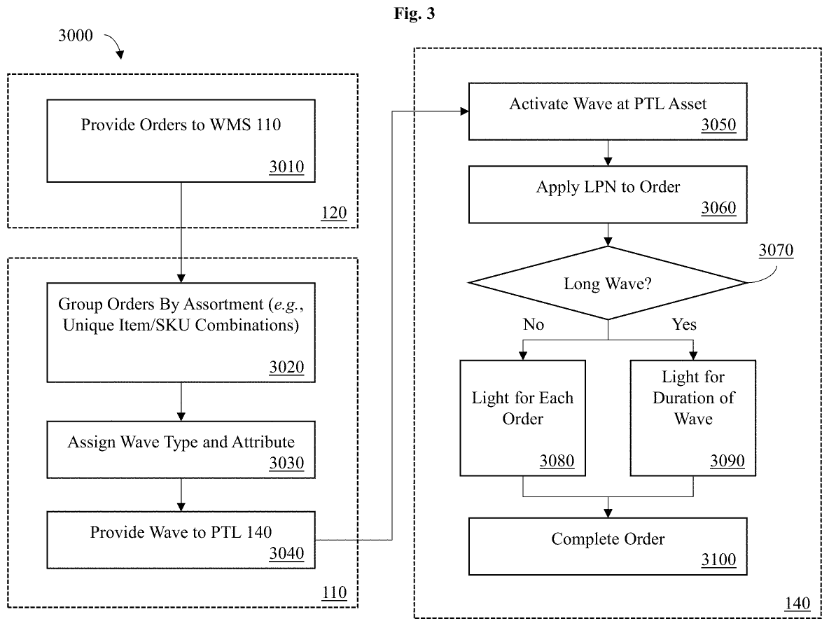

The order fulfillment system 100 can provide a dynamic order fulfillment mapping as described herein, such as with reference to an exemplary process 3000 shown in FIG. 3. Turning to FIG. 3, the OMS 120 provides customer orders to the WMS 110, at step 3010. In some embodiments, the customer order can define customer information, a shipping address, a status of billing, SKUs of the customer order, and various Booleans (e.g., whether the order is only for a box or includes additional items). Although shown and described as an OMS 120, the WMS 110 can cooperate with any number of supply chain management software platforms, such as HighJump Warehouse Management System® from Körber AG in Hamburg, Germany.

Once customer orders are received at the WMS 110, the orders are automatically grouped into waves (i.e., the wave of orders 130) to be sent to the pick-to-light system 140 for import and translation into orders that can be processed as machine-readable instructions on a physical picking system. By way of example, the first step in the process can include grouping all open un-waved orders, at step 3020, by assortment (e.g., unique items/SKU combinations). For example, each group can include at least one order with identical unique SKU combinations. Second, the WMS 110 can assign a unique identifier for each group (e.g., Group 1 comprises 5,000 orders, each order with SKUs X, Y, Z; Group 2 comprises 500 orders each with SKUs A, F, G; Group 3 comprises 2 orders each with SKUs M, N, O; Group 4 comprises 500 orders of one order each with a unique SKU assortment that differs from all other orders and their SKU variety). The identifier can be in the format of “Group number:Number of identical orders:SKUs in each order” (e.g., 1:5000:XYZ).

The WMS 110 then assigns wave attributes, at step 3030, as either a long or a short run based on the presence of all identical SKY combination orders or orders within a wave having varying SKU combinations. As previously described, the wave of orders 130 can be defined in part by both the number of orders having a predefined item composition attribute and the composition attribute itself. In some embodiments, creating the wave of orders 130 includes combining more than one order based on said item composition characteristics of the orders into a wave with a wave attribute. One wave attribute may be associated with orders sharing identical item composition and therefore may be directly associated with the items in those orders. Another wave attribute may be associated with a group of orders with item composition differences.

It should be noted that the entirety of an order need not be completed in any one pick area of a pick to light or other system or sorter. For example, the systems and methods disclosed herein preferably refers to the waving and processing of orders within a particular technology application, such as pick to light line, a continuous Bombay, and/or T-sorter application.

By way of example, an exemplary wave of orders 130 can include a wave type A. The wave type A has greater than a predetermined x number of orders, where at least a predetermined y percentage of the x number of orders have unique item combinations that do not match another order of the wave. For example, the wave type A can have at least one hundred orders where at least eighty percent of those orders have unique item combinations that do not match another order in the wave. In this example, the composition attribute of the wave is the difference in compositions and the wave has at least y percentage of orders with this unique item composition.

In some embodiments, the order attributes are assessed by the system by how many orders share identical item compositions and which orders do not. The wave is then defined by a number of orders sharing attributes of either the same item composition or orders of differing item compositions. The wave of orders 130 is a group of orders. The waves comprise at least two different wave types: all orders in the wave have an identical bill of material, or all orders in the wave have uniquely different bills of material.

Continuing with the example above, the wave attribute (A) can then be created such that the attributes are associated with either a “long” or “short” wave/run. For example, a long wave can include at least Y orders (e.g., 20 orders) such that the attribute “AY” defines a long wave and “A” defines a short-wave comprising N orders. The N orders can include more than one group of orders where each group has less than Y orders. Therefore, a long wave AY may have at least 20 orders with identical SKU combinations; a short wave A can have any number of orders in groups of at least one, where less than Y or 20 orders within the group have the same SKU combination. And orders across groups all have different SKU combinations.

The WMS 110 sends the generated wave of orders 130 to the pick-to-light system 140. Using these waves, the order fulfillment system 100 executes a waving process (W) (assigning an order group to a pick-to-light asset), at step 3040. Additionally and/or alternatively, waves 130 can be created by an asset manually or by a scan of a license plate number (LPN) barcode of a first order of a new wave, at 3060. Similarly, waves can be manually or automatically completed, for example, by a scan of an encoded order data on an individual order which is the last order of the wave.

The pick-to-light system 140 cooperates with both long runs and short runs, as desired, at step 3070. Long runs refer to those waves of identical bill of materials (e.g., the SKUs within the carton) that are larger in quantity. When long runs are loaded into the WMS 110, the WMS 110 causes lights of the pick-to-light system 140 to turn on and keeps them on until the wave is complete, at step 3090. In other words, where a wave of a desired number of orders with identical item compositions is sent to a pick-to-light asset, the lights associated with items in that asset remain on for the duration of picking of that order wave.

A kit count (i.e., the wave quantity remaining) will display on each work indicator on the line. Upon a successful induction scan, the kit count decrements. When a post-PTL induction scan identifies the final LPN from the long run wave, the wave is closed.

Advantageously, the order fulfillment system 100 can accommodate one or more short runs, at 3080. Unlike running a wave of identical bill of materials, each of these runs will have a unique mix of SKUs. In other words, where a wave of a desired number of orders or groups of orders with varying item compositions, the pick-to-light asset to which the wave is sent triggers lights associated with items order-by-order. Lights can be extinguished by an operator when an item associated with an order is picked complete.

The work indicator can show the last four digits of the LPN barcode and give display a status indicator (e.g., PICK, PASS, or DONE). For example, a PICK status indicator signals to the operator to pick the products lit by the wave; a PASS status indicator signals to the operator to pass to the next pick zone; a DONE status indicator signals to the operator that all picks have been complete.

For both long and short runs, the order fulfillment system 100 waits for a wave to be activated via a wave start message. The order fulfillment system 100 displays the containers to pick for the long runs in all work indicators. When the first container for the wave is scanned, the order fulfillment system 100 loads the work for the long runs. A task is marked as complete from the last work indicator in the zone in the event the last pick confirms in the wave fails.

In the example above, the waving process waves an AY wave attribute groups to assets to cause the lights in each bay with a SKU to pick, which light remains on while the wave is processed; and A attribute waves to assets where each bay lights for a SKU to pick for each order; where the waving logic commences with the scanning of an LPN or unique order identifier which associates the order both to a person and to a wave; upon induction into the pick-to-light asset.

The wave attributes can be used to define the mode of operation of the order processing system (e.g., the pick-to-light system 140 or an A-frame system). For example, the wave attribute for orders with identical item compositions can provide the order processing system the items needed for all of its orders directly. In this example, the pick-to-light system 140 can keep all lights on in all bays until the orders in its wave are picked and confirmed and orders are completed. In other examples, the A-frame can dispense the same contents for each order or even pre-queue dispensed items for such orders in totes.

Additionally and/or alternatively, a wave attribute can instruct the order processing system to obtain the item pick requirements for each order from a scanned order identification, such as the LPN. In this embodiment, because the item composition of the orders in this wave are not all identical, subsequent processing of each order is unique. The pick-to-light system 140 can light pick locations based on items associated with each unique order in the pick area currently associated with that order.

In some embodiments, the pick-to-light system 140 produces pick-rate reports, analyzes productivity, and other metrics, and also allow for variances in the size of work zones to account for labor-to-order volume needs.

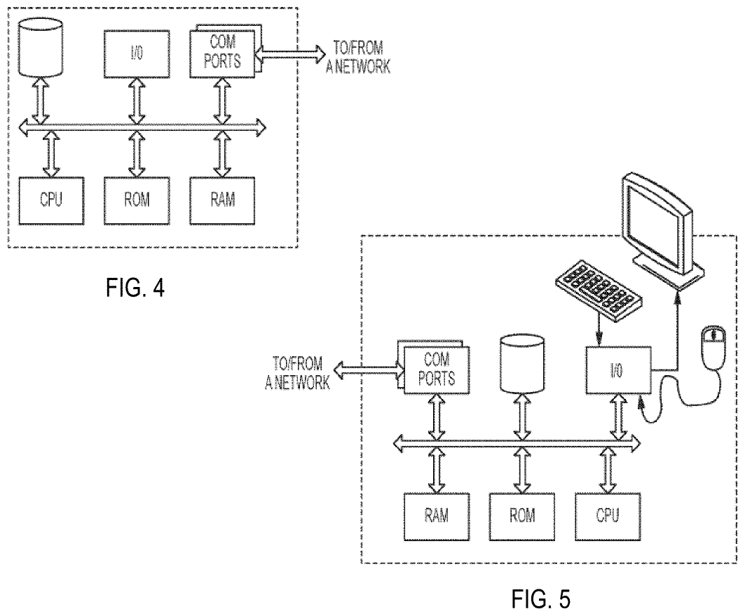

FIGS. 4 and 5 provide functional block diagram illustrations of computer hardware platforms that can be used with the order fulfillment system 100. FIG. 4 illustrates a network or host computer platform, as may typically be used to implement a server such as any of the servers described herein. FIG. 5 depicts a computer with user interface elements, as may be used to implement a control system (not shown) or other type of work station or terminal device of the order fulfillment system 100, although the computer of FIG. 5 may also act as a server if appropriately programmed. It is believed that those skilled in the art are familiar with the structure, programming and general operation of such computer equipment and as a result the drawings should be self-explanatory.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A computer-based method for order fulfillment of one or more electronic inventory orders comprising:
determining, via a warehouse management system, an item composition of the electronic inventory orders;
determining, via the warehouse management system, a degree of similarity of the determined item composition;
grouping, via the warehouse management system, the electronic inventory orders into a wave of orders as a function of the determined degree of similarity;
assigning a wave attribute to the grouped wave of orders, the wave attribute being defined as a function of the determined degree of similarity; and
assigning the grouped wave of orders and the assigned wave attribute to an electro-mechanical item function of a warehouse, wherein the grouped wave of orders and the assigned wave attribute represents machine-readable instructions for processing on the electro-mechanical item function.

2. The computer-based method of claim 1, wherein said assigning the grouped wave or orders and the assigned wave attribute to the electro-mechanical item function comprises assigning the grouped wave or orders and the assigned wave attribute to at least one of a pick-to-light system, a unit sortation system, a radio frequency device, an automated storage system, an and an A-frame system.

3. The computer-based method of claim 1, further comprising automatically triggering one or more lights of the electro-mechanical item function to illuminate based on the assigned group wave of orders.

4. The computer-based method of claim 1, wherein said determining the degree of similarity of the determined item composition is based on a stock keeping unit number for each item of the determined item composition.

5. The computer-based method of claim 4, wherein said grouping the electronic inventory orders into a wave of orders as a function of the determined degree of similarity comprises grouping the electronic inventory orders into a wave of orders, wherein each wave includes items forming an identical combination of stock keeping unit numbers.

6. The computer-based method of claim 1, wherein said assigning the wave attribute to the grouped wave of orders comprises defining the grouped wave of orders as one of a long run or a short run.

7. The computer-based method of claim 6, wherein the long run is assigned to the grouped wave or orders having at least a predetermined number of orders and the short run is assigned to all other orders.

8. A system for order fulfillment of one or more electronic inventory orders comprising:
a warehouse management system; and
an automated picking system in operable communication with the warehouse management system,
wherein said warehouse management system determines an item composition of the electronic inventory orders, determines a degree of similarity of the determined item composition, groups the electronic inventory orders into a wave of orders as a function of the determined degree of similarity, assigns a wave attribute to the grouped wave of orders, the wave attribute being defined as a function of the determined degree of similarity, and assigns the grouped wave of orders and the assigned wave attribute to the automated picking system.

9. The system of claim 8, wherein said automated picking system comprises at least one of a pick-to-light system, a unit sortation system, a radio frequency device, an automated storage system, an and an A-frame system.

10. The system of claim 8, wherein said warehouse management system automatically triggers one or more lights of the automated picking system to illuminate based on the assigned group wave of orders.

11. The system of claim 8, wherein said warehouse management system determines the degree of similarity of the determined item composition based on a stock keeping unit number for each item of the determined item composition.

12. The system of claim 11, wherein said warehouse management system groups the electronic inventory orders into a wave of orders as a function of the determined degree of similarity by grouping the electronic inventory orders into a wave of orders, wherein each wave includes items forming an identical combination of stock keeping unit numbers.

13. The system of claim 8, wherein said warehouse management system assigns the wave attribute to the grouped wave of orders by defining the grouped wave of orders as one of a long run or a short run.

14. The system of claim 13, wherein the long run is assigned to the grouped wave or orders having at least a predetermined number of orders and the short run is assigned to all other orders.

15. A non-transitory computer-readable medium storing instructions that, when executed by a processor, performs operations for order fulfillment of one or more electronic inventory orders, the operations comprising:
determining an item composition of the electronic inventory orders;
determining a degree of similarity of the determined item composition;
grouping the electronic inventory orders into a wave of orders as a function of the determined degree of similarity;
assigning a wave attribute to the grouped wave of orders, the wave attribute being defined as a function of the determined degree of similarity; and
assigning the grouped wave of orders and the assigned wave attribute to an electro-mechanical item function of a warehouse, wherein the grouped wave of orders and the assigned wave attribute represents machine-readable instructions for processing on the electro-mechanical item function.

16. The non-transitory computer-readable medium storing instructions that perform the operations of claim 15, wherein said assigning the grouped wave or orders and the assigned wave attribute to the electro-mechanical item function comprises assigning the grouped wave or orders and the assigned wave attribute to at least one of a pick-to-light system, a unit sortation system, a radio frequency device, an automated storage system, an and an A-frame system.

17. The non-transitory computer-readable medium storing instructions that perform the operations of claim 15, further comprising automatically triggering one or more lights of the electro-mechanical item function to illuminate based on the assigned group wave of orders.

18. The non-transitory computer-readable medium storing instructions that perform the operations of claim 15, wherein said determining the degree of similarity of the determined item composition is based on a stock keeping unit number for each item of the determined item composition.

19. The non-transitory computer-readable medium storing instructions that perform the operations of claim 18, wherein said grouping the electronic inventory orders into a wave of orders as a function of the determined degree of similarity comprises grouping the electronic inventory orders into a wave of orders, wherein each wave includes items forming an identical combination of stock keeping unit numbers.

20. The non-transitory computer-readable medium storing instructions that perform the operations of claim 15, wherein said assigning the wave attribute to the grouped wave of orders comprises defining the grouped wave of orders as one of a long run or a short run.
